(19) United States
(12) Patent Application Publication
(10) Pub. No.: US 2026/0370578 A1
(43) Pub. Date: Nov. 19, 2026

(54) USER DATA OFFLOAD BETWEEN WIRELESS ACCESS NODES

(71) Applicant: T-MOBILE INNOVATIONS LLC, Overland Park, KS (US)

(72) Inventor: John Carlo Hernandez Ventura, Sammamish, WA (US)

(21) Appl. No.: 19/208,263

(22) Filed: May 14, 2025

(51) Int. Cl. H04L 43/06; H04B 7/06; H04B 17/309; H04L 43/0823

(52) U.S. Cl. CPC H04L 43/06; H04B 7/0632; H04B 17/346; H04L 43/0823

(57) ABSTRACT

In some examples, a first access node wirelessly transfers a first amount of data between a user device and the first access node. A second access node wirelessly transfers a second amount of data between the user device and the second access node. The first access node determines one or more wireless communication characteristics for the wireless transfer of the second amount of the data. The first access node selects an entire amount of additional data based on the one or more wireless communication characteristics. The first access node transfers the entire amount of the additional data between the second access node and the first access node. The second access node transfers the entire amount of the additional data between the second access node and the first access node and wirelessly transfers the entire amount of the additional data between the user device and the second access node.

### TECHNICAL BACKGROUND

Wireless data systems provide wireless data services to wireless user devices like phones, vehicles, robots, and computers. The wireless data services include internet-access, machine-communications, media-streaming, or some other data product. For example, a fleet of aerial vehicles may use a wireless communication network for vehicle tracking and control. In another example, a team of gamers may use wireless internet access to play an interactive augmented-reality game. The wireless data systems comprise wireless access nodes like communication satellites, new radio NodeBs, and wireless fidelity hotspots. The wireless user devices and the wireless access nodes exchange network signaling and user data to implement these wireless data services.

The wireless access nodes use Carrier Aggregation (CA) to increase the Radio Frequency (RF) bandwidth for the wireless user devices. The increased RF bandwidth generally improves the data rate and the reliability of the wireless data services. CA simultaneously uses multiple wireless access nodes and frequency bands in parallel to serve the same wireless user device. Initially, the wireless user device selects and uses a primary wireless access node. If the data in the uplink buffer in the wireless user device and/or the data in the downlink buffer in the primary wireless access node exceeds a CA threshold, then the primary wireless access node selects a secondary wireless access node to help. The selection is based on which secondary wireless access node has the most RF bandwidth. For example, a wireless access node with 200 megahertz of bandwidth would be selected over another wireless access node with 100 megahertz of bandwidth.

For the uplink, the wireless user device buffers its uplink data. The wireless user device transfers its buffered uplink data that is below the CA threshold to the primary wireless access node. The wireless user device transfers the buffered uplink data that exceeds the CA threshold to the secondary wireless access node, and the secondary wireless access node forwards this excess uplink data to the primary wireless access node. The primary wireless access node transfers all of the uplink data to a network core.

For the downlink, the primary wireless access node receives downlink data from the network core. The primary wireless access buffers the downlink data. The primary wireless access node transfers its buffered downlink data that is below the CA threshold to the wireless user device. The primary wireless access node transfers its buffered downlink data that exceeds the CA threshold to the secondary wireless access node, and the secondary wireless access node forwards this excess downlink data to the wireless user device.

### TECHNICAL OVERVIEW

In some examples, a wireless communication system comprises a first wireless access node and a second wireless access node. The first wireless access node wirelessly transfers a first amount of user data between a wireless user device and the first wireless access node. The second wireless access node wirelessly transfers a second amount of user data between the wireless user device and the second wireless access node. The first wireless access node determines one or more wireless communication characteristics for the wireless transfer of the second amount of the user data between the wireless user device and the second wireless access node. The first wireless access node selects an entire amount of additional user data based on the one or more wireless communication characteristics. The first wireless access node transfers the entire amount of the additional user data between the second wireless access node and the first wireless access node. The second wireless access node transfers the entire amount of the additional user data between the second wireless access node and the first wireless access node and wirelessly transfers the entire amount of the additional user data between the wireless user device and the second wireless access node.

In some examples, a method comprises the following operations. Select a first amount of user data for a first wireless access node to wirelessly transfer to a wireless user device. Select a second amount of the user data for a second wireless access node to wirelessly transfer to the wireless user device. Determine one or more wireless communication characteristics for the wireless transfer of the second amount of the user data. Based on the one or more wireless communication characteristics, select an entire amount of additional user data for the first wireless access node to transfer to the second wireless access node and for the second wireless access node to wirelessly transfer to the wireless user device.

In some examples, a method comprises the following operations. Select a first amount of user data for a wireless user device to wirelessly transfer to a first wireless access node. Select a second amount of the user data for the wireless user device to wirelessly transfer to a second wireless access node. Determine one or more wireless communication characteristics for the wireless transfer of the second amount of the user data. Based on the one or more wireless communication characteristics, select an entire amount of additional user data for the wireless user device to wirelessly transfer to the second wireless access node and for the second wireless access node to transfer to the first wireless access node.

### DESCRIPTION OF THE DRAWINGS

FIG. 1 illustrates an exemplary data system to offload user data from a first wireless access node to a second wireless access node.

FIG. 2 illustrates an exemplary operation of the data system to offload downlink user data from the first wireless access node to the second wireless access node.

FIG. 3 illustrates an exemplary operation of the data system to offload uplink user data from the first wireless access node to the second wireless access node.

FIG. 4 illustrates an exemplary operation of the data system to offload the user data from the first wireless access node to the second wireless access node.

FIG. 5 illustrates an exemplary wireless communication network to offload user data from a first wireless access node to a second wireless access node.

FIG. 6 illustrates an exemplary User Equipment (UE) in the wireless communication network that offloads user data from the first wireless access node to the second wireless access node.

FIG. 7 illustrates an exemplary terrestrial Fifth Generation New Radio (5GNR) access node in the wireless communication network that offloads user data from the first wireless access node to the second wireless access node.

FIG. 8 illustrates an exemplary Wireless Fidelity (WIFI) access node in the wireless communication network that offloads user data from the first wireless access node to the second wireless access node.

FIG. 9 illustrates an exemplary Satellite (SAT) AN and SAT Ground Station (GND) in the wireless communication network that offloads user data from the first wireless access node to the second wireless access node.

FIG. 10 illustrates an exemplary Network Function Virtualization Infrastructure (NFVI) in the wireless communication network that offloads user data from the first wireless access node to the second wireless access node.

FIG. 11 illustrates an exemplary operation of the wireless communication network to select and use the second wireless access node.

FIG. 12 illustrates an exemplary operation of the wireless communication network to select a data amount to offload from the first wireless access node to the second wireless access node.

FIG. 13 illustrates exemplary processing circuitry to offload user data from a first wireless access node to a second wireless access node.

### DETAILED DESCRIPTION

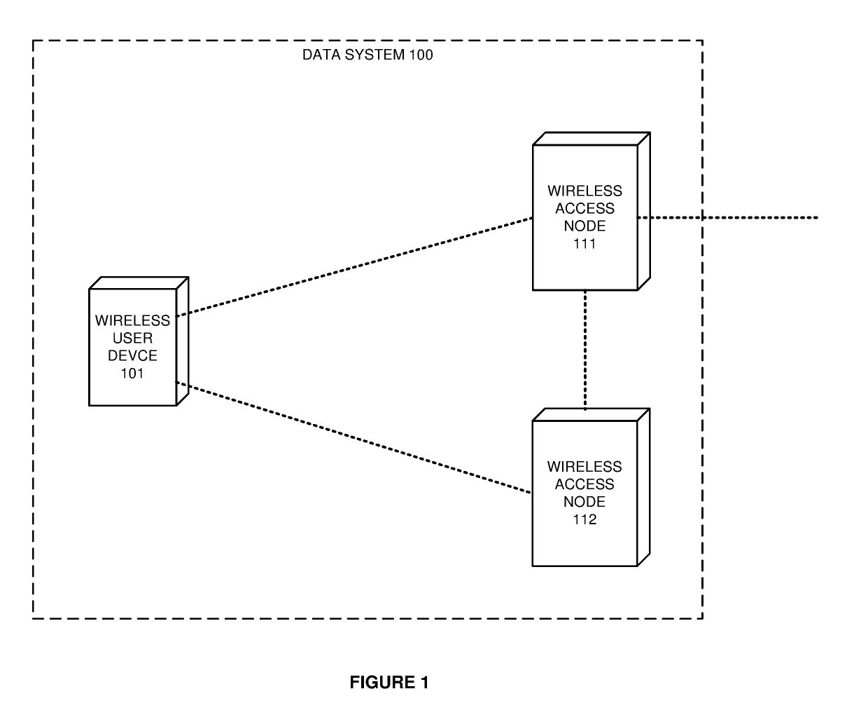

FIG. 1 illustrates exemplary data system 100 to offload user data from wireless access node 111 to wireless access node 112. Data system 100 provides data services like internet-access, machine control, video-calling, data messaging, and the like. Data system 100 comprises wireless user device 101 and wireless access nodes 111-112. Wireless user device 101 could be a phone, computer, vehicle, robot, and/or some other user apparatus with wireless communication components. Wireless access nodes 111-112 could be NodeBs, hotspots, satellites, and/or some other type of wireless transceivers.

In some examples, wireless access node 111 wirelessly transfers a first amount of user data between wireless user device 101 and wireless access node 111. Wireless access node 112 wirelessly transfers a second amount of user data between wireless user device 101 and wireless access node 112. These data transfers could be uplink downlink, or both uplink and downlink. Wireless access node 111 determines one or more wireless communication characteristics for the wireless transfer of the second amount of the user data between wireless user device 101 and wireless access node 112. The one or more wireless communication characteristics could be Signal-to-Interference and Noise Ratio (SINR), Block Error Rate (BLER), Channel Quality Indicator (CQI), node 111 bandwidth, node 112 bandwidth, and/or some other communication metrics. Wireless access node 111 selects an entire amount of additional user data based on the one or more wireless communication characteristics. Wireless access node 111 transfers the entire amount of the additional user data between the wireless access node 112 and wireless access node 111. Wireless access node 112 transfers the entire amount of the additional user data between the wireless access node 112 and wireless access node 111. Wireless access node 112 wirelessly transfers the entire amount of the additional user data between wireless user device 101 and wireless access node 112. These additional user data transfers could be uplink downlink, or both uplink and downlink.

The above operation may comprise Carrier Aggregation (CA). In CA, wireless access node 111 is referred to as a PCell, and wireless access node 112 is referred to as an SCell. The PCell and the SCell use different wireless transceivers like different Remote Radio Units (RRUs). The different RRUs wirelessly communicate with wireless devices like wireless user device 101 using different carrier bands. The PCell and the SCell may be co-located at the same wireless base station like the same nodeB. When the PCell and the SCell are co-located, the PCell and the SCell may be connected to the same Baseband Unit (BBU) of the shared base station.

In some examples, wireless user device 101 and wireless access nodes 111-112 wirelessly communicate using wireless protocols like Wireless Fidelity (WIFI), Fifth Generation New Radio (5GNR), Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), satellite data communications and/or some other wireless protocol. Wireless user device 101 and wireless access nodes 111-112 comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of data system 100 as described herein.

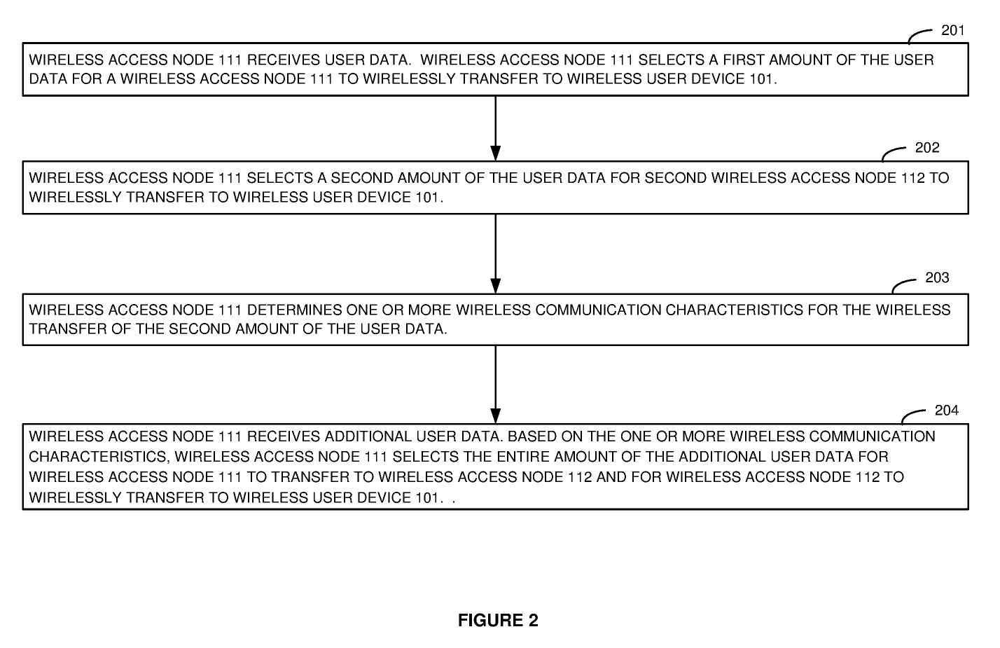

FIG. 2 illustrates an exemplary operation of data system 100 to offload downlink user data from the wireless access node 111 to the wireless access node 112. The operation may differ in other examples. Wireless access node 111 receives user data and selects a first amount of the user data to wirelessly transfer to wireless user device 101 (201). Wireless access node 111 selects a second amount of the user data for wireless access node 112 to wirelessly transfer to wireless user device 101 (202). For example, wireless access node 111 may store downlink data in a memory buffer that has a data threshold. The first amount of the user data comprises the downlink data in the memory buffer that is at or below the data threshold. The second amount of the user data comprises the downlink data in the memory buffer that is at or above the data threshold. Wireless access node 111 determines one or more wireless communication characteristics for the wireless transfer of the second amount of the user data from wireless access node 112 to wireless user device 101 (203). For example, wireless user device 101 may report the SINR, BLER, and CQI for this downlink user data transfer. Wireless access node 111 receives additional user data, and based on the one or more wireless communication characteristics, wireless access node 111 selects the entire amount of the additional user data for wireless access node 111 to transfer to wireless access node 112 and for wireless access node 112 to wirelessly transfer to wireless user device 101 (204).

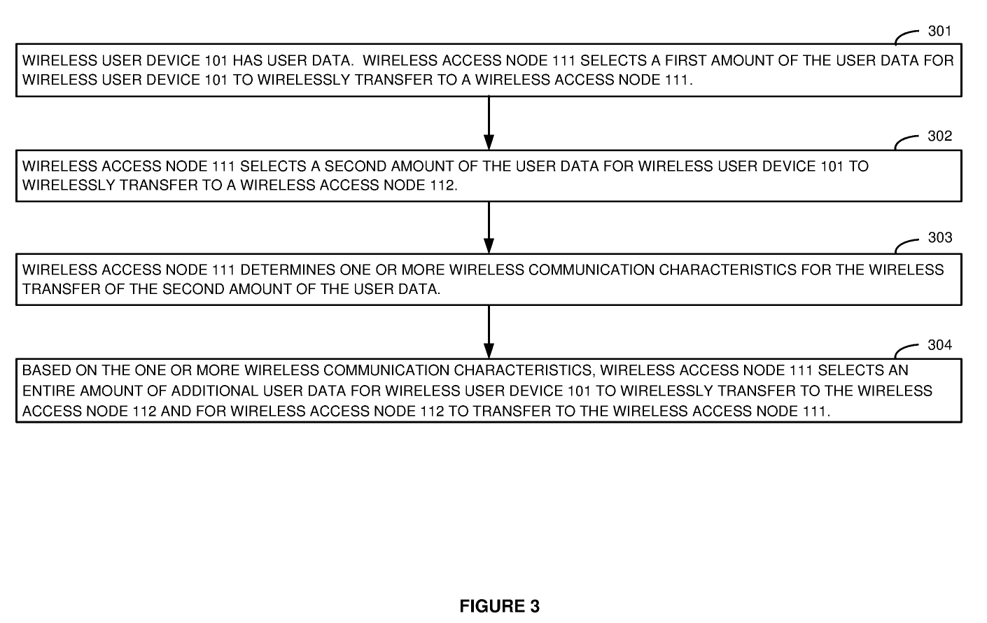

FIG. 3 illustrates an exemplary operation of data system 100 to offload uplink user data from wireless access node 111 to wireless access node 112. The operation may differ in other examples. Wireless user device 101 has user data (301). Wireless access node 111 selects a first amount of the user data for wireless user device 101 to wirelessly transfer to wireless access node 111 (301). Wireless access node 111 selects a second amount of user data for wireless user device 101 to wirelessly transfer to wireless access node 112 (302). For example, wireless user device 101 may store uplink data in a memory buffer that has a data threshold. The first amount of the user data comprises the uplink data in the memory buffer that is at or below the data threshold. The second amount of the user data comprises the uplink data in the memory buffer that is at or above the data threshold. Wireless access node 112 determines one or more wireless communication characteristics for the wireless transfer of the user data from wireless user device 101 to wireless access node 112 (303). For example, wireless user device 101 may report the SINR, BLER, and CQI for the uplink user data transfer. Wireless user device 101 has additional user data (304). Based on the one or more wireless communication characteristics, wireless access node 111 selects the entire amount of the additional user data for wireless user device 101 to wirelessly transfer to wireless access node 112 and for wireless access node 112 to transfer to wireless access node 111 (304).

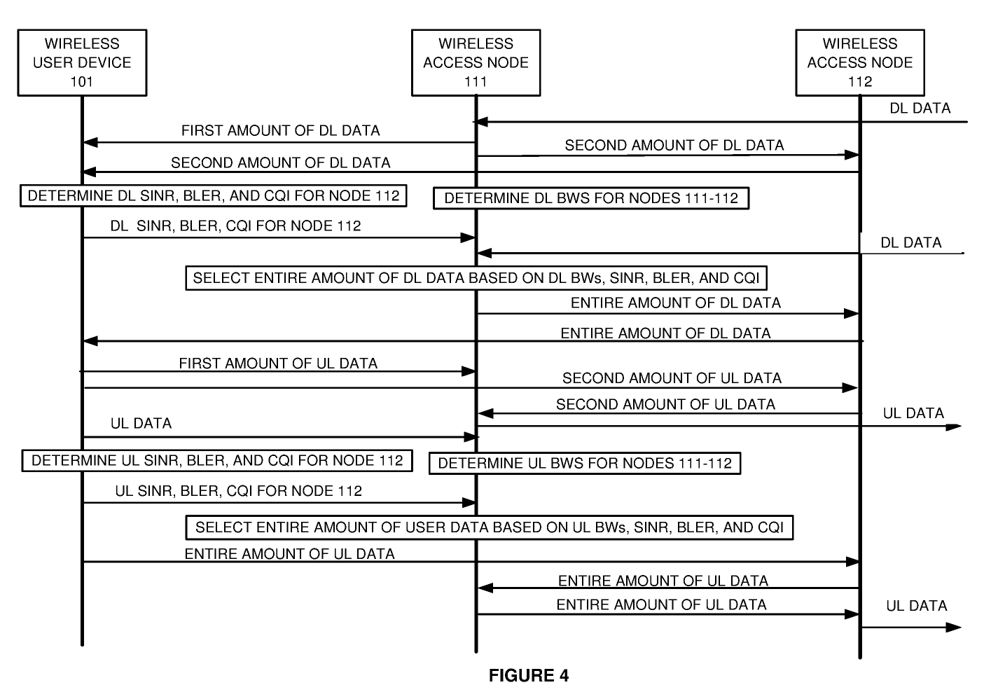

FIG. 4 illustrates an exemplary operation of data system 100 to offload the user data from wireless access node 111 to wireless access node 112. The operation may differ in other examples. Wireless access node 111 receives Downlink (DL) data from an external system (not shown). Wireless access node 111 wirelessly transfers a first amount of the DL data to wireless user device 101. Wireless access node 111 transfers a second amount of the DL data to wireless access node 112, and wireless access node 112 wirelessly transfers the second amount of the DL data to wireless user device 101. Wireless access node 111 determines the DL bandwidths of wireless access nodes 111-112. Wireless user device 101 determines SINR, BLER, and CQI for the downlink data transfer from wireless access node 112. Wireless user device 101 indicates the DL SINR, BLER, and CQI to wireless access node 111. Wireless access node 111 receives additional DL data. Based on the DL bandwidths, SINR, BLER, and CQI, wireless access node 111 selects the entire amount of the additional DL data for offload to wireless access node 112. Wireless access node 111 transfers the entire amount of the additional DL data to wireless access node 112. Wireless access node 112 wirelessly transfers the entire amount of the additional DL data to wireless user device 101.

Wireless user device 101 wirelessly transfers a first amount of Uplink (UL) data to wireless access node 111. Wireless user device 101 wirelessly transfers a second amount of UL data to wireless access node 112. Wireless access node 112 transfers the second amount of the UL data to wireless access node 111. Wireless access node transfers the UL data to the external system. Wireless user device 101 determines UL SINR, BLER, and CQI for the uplink data transfer. Wireless access node 111 determines the UL bandwidths of wireless access nodes 111-112. Wireless user device 101 indicates the UL SINR, BLER, and CQI to wireless access node 111. Based on the UL bandwidths, SINR, BLER, and CQI, wireless access node 111 selects the entire amount of the additional UL data for offload to wireless access node 112. Wireless user device 101 wirelessly transfers the entire amount of the UL data to wireless access node 112. Wireless access node 112 transfers the entire amount of the UL data to wireless access node 111. Wireless access node 111 transfers the UL data to the external system.

Advantageously, primary wireless access node 111 efficiently offloads entire amounts of buffered user data for wireless user device 101 to secondary wireless access node 112. Moreover, primary access node 111 verifies the ability of secondary wireless access node 112 to handle these total offloads before the offloads are attempted.

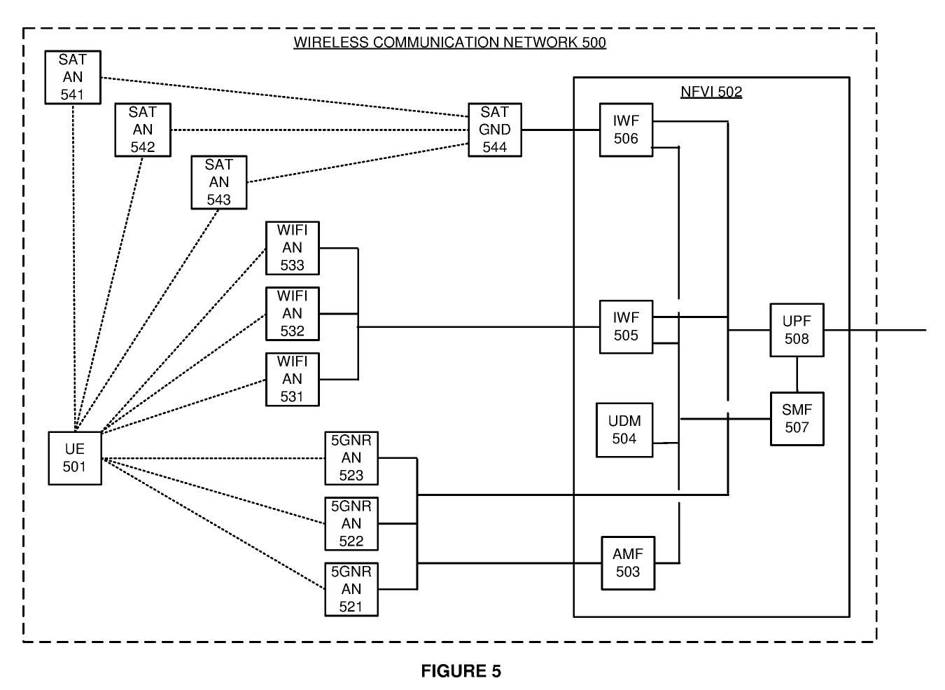

FIG. 5 illustrates an exemplary wireless communication network to offload user data from a first wireless access node to a second wireless access node. Wireless communication network 500 comprises an example of data system 100, although system 100 may differ. Wireless communication network 500 comprises User Equipment (UE) 501, Fifth Generation New Radio Access Nodes (5GNR ANs) 521-523, Wireless Fidelity Access Nodes (WIFI ANs) 531-533, Satellite Access Nodes (SAT ANs) 541-543, Satellite Ground Station (SAT GND) 544, and Network Function Virtualization Infrastructure (NFVI) 502. NFVI 502 comprises Access and Mobility Management Function (AMF) 503, Unified Data Management (UDM) 504, Interworking Functions (IWFs) 505-506, Session Management Function (SMF) 507, and User Plane Function (UPF) 508.

In a first example, UE 501 attaches to 5GNR AN 521 which operates as a Carrier Aggregation (CA) Primary Cell (PCell). UE 501 registers with AMF 503 over primary 5GNR AN 521. During the registration, UE 501 reports its CA capabilities like carrier bands to primary 5GNR AN 521. AMF 503 retrieves the subscriber profile for UE 501 from UDM 504. AMF 503 and SMF 507 interact to develop context for UE 501 like device and node identifiers, network addresses, and data rates. SMF 507 transfers the context to UPF 508. AMF 503 transfers the context to primary 5GNR AN 521. AMF 503 transfers the context to UE 501 over primary 5GNR AN 521. In response to the context, UE 501 wirelessly exchanges user data with external systems (not shown) over primary 5GNR AN 521 and UPF 508.

UE 501 reports its uplink buffer status to primary 5GNR AN 521. Primary 5GNR AN 521 determines its own downlink buffer status for UE 501. When one of the buffers exceeds a CA threshold, primary 5GNR AN 521 transfers a Radio Resource Control (RRC) Reconfiguration message to UE 501 that requests UE 501 to report which of ANs 522-523, if any, have a Reference Signal Received Power (RSRP) above an RSRP threshold. UE 501 measures the RSRP for secondary 5GNR ANs 522-523 and determines that AN 522 has an RSRP above the RSRP threshold but AN 523 does not. UE 501 returns an RRC Reconfiguration Complete message to primary 5GNR AN 521 that indicates secondary 5GNR AN 522 and its RSRP measurement. Primary 5GNR AN 521 confirms that secondary 5GNR AN 522 has an RSRP above the RSRP threshold. Secondary 5GNR AN 522 will operate as a CA Secondary Cell (SCell).

If the uplink buffer in UE 501 has user data in excess of the CA threshold, then primary 5GNR AN 521 signals UE 501 to transfer the excess portion of the uplink data to secondary 5GNR AN 522. Primary 5GNR AN 521 signals secondary 5GNR AN 522 to receive this excess uplink data from UE 501 and to forward the excess uplink data to primary 5GNR AN 521. In response, UE 501 transfers the excess portion of the uplink data to secondary 5GNR AN 522, and secondary 5GNR AN 522 forwards this excess uplink data to primary 5GNR AN 521. UE 501 transfers the remaining portion of the uplink data directly to primary 5GNR AN 521. Primary 5GNR AN 521 transfers all of the uplink data to the external system over UPF 508. UE 501 determines Signal-to-Interference and Noise Ratio (SINR), Block Error Rate (BLER), and Channel Quality Indicator (CQI) for secondary 5GNR AN 522 during this uplink data transfer.

If the downlink buffer in 5GNR AN 521 has user data for UE 501 in excess of the CA threshold, then primary 5GNR AN 521 signals secondary 5GNR AN 522 to receive this excess downlink data from primary 5GNR AN 521 and forward the excess downlink data to UE 501. Primary 5GNR AN 521 signals UE 501 to receive the excess downlink data from secondary 5GNR AN 522. In response, primary 5GNR AN 521 transfers the excess portion of the downlink data to secondary 5GNR AN 522, and secondary 5GNR AN 522 forwards this excess downlink data to UE 501. Primary 5GNR AN 521 transfers the remaining portion of the downlink data directly to UE 501. UE 501 determines the SINR, BLER, and CQI for secondary 5GNR AN 522 during this downlink data transfer.

UE 501 subsequently reports its uplink buffer status to primary 5GNR AN 521. Primary 5GNR AN 521 determines its own downlink buffer status for UE 501. When one of the buffers exceeds the CA threshold, primary 5GNR AN 521 determines if secondary 5GNR AN 522 has more available bandwidth for UE 501 than primary 5GNR AN 521 does. For example, primary 5GNR AN 521 may have a bandwidth of 100 megahertz while secondary 5GNR AN 522 has a bandwidth of 200 megahertz. When secondary 5GNR AN 522 has more available bandwidth, primary 5GNR AN 521 transfers an RRC Reconfiguration message to UE 501 that requests the SINR, BLER, and CQI for secondary 5GNR AN 522. UE 501 reports the SINR, BLER, and CQI for secondary 5GNR AN 522 to primary 5GNR AN 521. Primary 5GNR AN 521 compares the SINR, BLER, and CQI for secondary 5GNR AN 522 to corresponding SINR, BLER, and CQI thresholds. When secondary 5GNR AN 522 meets or exceeds these SINR, BLER, and CQI thresholds, primary 5GNR AN 521 offloads all of the buffered uplink data in UE 501 and/or all of the buffered downlink data in primary 5GNR AN 521 to secondary 5GNR AN 522. Note that all of the uplink and/or downlink data is offloaded in this example, and not just the excess portion of the data that is above the CA threshold.

To offload all of the uplink data, primary 5GNR AN 521 signals UE 501 to transfer all of the uplink data to secondary 5GNR AN 522. Primary 5GNR AN 521 signals secondary 5GNR AN 522 to receive all of the uplink data from UE 501 and to forward all of the uplink data to primary 5GNR AN 521. In response, UE 501 transfers the all of its buffered uplink data to secondary 5GNR AN 522, and secondary 5GNR AN 522 forwards all of this uplink data to primary 5GNR AN 521. Primary 5GNR AN 521 transfers all of the uplink data to the external system over UPF 508.

To offload all of the downlink data, primary 5GNR AN 521 signals secondary 5GNR AN 522 to receive all of the downlink data from primary 5GNR AN 521 and forward all of the downlink data to UE 501. Primary 5GNR AN 521 signals UE 501 to receive all of the downlink data from secondary 5GNR AN 522. In response, primary 5GNR AN 521 transfers all of its buffered downlink data to secondary 5GNR AN 522, and secondary 5GNR AN 522 forwards all of this downlink data to UE 501.

In a second example, UE 501 attaches to SAT AN 541 which operates as the CA PCell. UE 501 registers with AMF 503 over SAT AN 541, SAT GND 544, and IWF 506. During the registration, UE 501 reports its capabilities for CA to primary SAT AN 541 like carrier bands. AMF 503 retrieves the subscriber profile for UE 501 from UDM 504. AMF 503 and SMF 507 interact to develop context for UE 501 like device and node identifiers, network addresses, and data rates. SMF 507 transfers the context to UPF 508. AMF 503 transfers the context to primary IWF 506. AMF 503 transfers the context to UE 501 over primary SAT AN 541. In response to the context, UE 501 wirelessly exchanges user data with the external systems over primary SAT AN 541, SAT GND 544, IWF 506, and UPF 508.

UE 501 reports its uplink buffer status to primary SAT AN 541. Primary SAT AN 541 determines its own downlink buffer status for UE 501. When one of the buffers exceeds a CA threshold, primary SAT AN 541 transfers a message to UE 501 that requests UE 501 to report which of ANs 542-543, if any, have a Received Signal Strength (RSS) above an RSS threshold. UE 501 measures the RSS for secondary SAT ANs 542-543 and determines that AN 542 has an RSS above the RSS threshold but AN 543 does not. UE 501 returns a message to primary SAT AN 541 that indicates secondary SAT AN 542 and its RSS measurement. Primary SAT AN 541 confirms that secondary SAT AN 542 has an RSS above the RSS threshold. Secondary SAT AN 542 will operate as a CA SCell.

If the uplink buffer in UE 501 has user data in excess of the CA threshold, then primary SAT AN 541 signals UE 501 to transfer the excess portion of the uplink data to secondary SAT AN 542. Primary SAT AN 541 signals secondary SAT AN 542 to receive this excess uplink data from UE 501 and to forward the excess uplink data to primary SAT AN 541. In response, UE 501 transfers the excess portion of the uplink data to secondary SAT AN 542, and secondary SAT AN 542 forwards this excess uplink data to primary SAT AN 541. UE 501 transfers the remaining portion of the uplink data directly to primary SAT AN 541. Primary SAT AN 541 transfers all of the uplink data to the external system over SAT GND 544, IWF 506, and UPF 508. UE 501 determines the Signal-to-Noise Ratio (SNR) and Error Rate (ER) for secondary SAT AN 542 during this uplink data transfer.

If the downlink buffer in SAT AN 541 has user data for UE 501 in excess of the CA threshold, then primary SAT AN 541 signals secondary SAT AN 542 to receive this excess downlink data from primary SAT AN 541 and forward the excess downlink data to UE 501. Primary SAT AN 541 signals UE 501 to receive the excess downlink data from secondary SAT AN 542. In response, primary SAT AN 541 transfers the excess portion of the downlink data to secondary SAT AN 542, and secondary SAT AN 542 forwards this excess downlink data to UE 501. Primary SAT AN 541 transfers the remaining portion of the downlink data directly to UE 501. UE 501 determines the SNR and ER for secondary SAT AN 542 during this downlink data transfer.

UE 501 subsequently reports its uplink buffer status to primary SAT AN 541. Primary SAT AN 541 determines its own downlink buffer status for UE 501. When one of the buffers exceeds a CA threshold, primary SAT AN 541 determines if secondary SAT AN 542 has more available bandwidth for UE 501 than AN 541 does. When secondary SAT AN 542 has more available bandwidth, primary SAT AN 541 transfers a message to UE 501 that requests the SNR and ER for secondary SAT AN 542. UE 501 reports the SNR and ER for secondary SAT AN 542 to primary SAT AN 541. Primary SAT AN 541 compares the SNR and ER for secondary SAT AN 542 to corresponding SNR and ER thresholds. When secondary SAT AN 542 meets or exceeds these SNR and ER thresholds, primary SAT AN 541 offloads all of the buffered uplink data in UE 501 and/or all of the buffered downlink data in primary SAT AN 541 to secondary SAT AN 542. Note that all of the uplink and/or downlink data is offloaded and not just the excess portion of data that is above the CA threshold.

To offload the uplink data, primary SAT AN 541 signals UE 501 to transfer all of its buffered uplink data to secondary SAT AN 542. Primary SAT AN 541 signals secondary SAT AN 542 to receive all of the uplink data from UE 501 and to forward all of this uplink data to primary SAT AN 541. In response, UE 501 transfers the all of its buffered uplink data to secondary SAT AN 542, and secondary SAT AN 542 forwards all of this uplink data to primary SAT AN 541. Primary SAT AN 541 transfers all of the uplink data to the external system over SAT GND 544, IWF 506, and UPF 508.

To offload the downlink data, primary SAT AN 541 signals secondary SAT AN 542 to receive all of the downlink data from primary SAT AN 541 and forward all of the downlink data to UE 501. Primary SAT AN 541 signals UE 501 to receive all of the downlink data from secondary SAT AN 542. In response, primary SAT AN 541 transfers all of its buffered downlink data to secondary SAT AN 542, and secondary SAT AN 542 forwards all of this downlink data to UE 501.

In a third example, UE 501 attaches to WIFI AN 531 which operates as the CA PCell. UE 501 registers with AMF 503 over WIFI AN 531 and IWF 505. During the registration, UE 501 reports its capabilities for CA to primary WIFI AN 531. AMF 503 retrieves the subscriber profile for UE 501 from UDM 504. AMF 503 and SMF 507 interact to develop context for UE 501 like device and node identifiers, network addresses, and data rates. SMF 507 transfers the context to UPF 508. AMF 503 transfers the context to IWF 505. AMF 503 transfers the context to UE 501 over primary WIFI AN 531. In response to the context, UE 501 wirelessly exchanges user data with the external systems over primary WIFI AN 531, IWF 505, and UPF 508.

UE 501 reports its uplink buffer status to primary WIFI AN 531. Primary WIFI AN 531 determines its own downlink buffer status for UE 501. When one of the buffers exceeds a CA threshold, primary WIFI AN 531 transfers a message to UE 501 that requests UE 501 to report which of ANs 532-533, if any, have an RSS above an RSS threshold. UE 501 measures the RSS for secondary WIFI ANs 532-533 and determines that AN 532 has an RSS above the RSS threshold but AN 533 does not. UE 501 returns a message to primary WIFI AN 531 that indicates secondary WIFI AN 532 and its RSS measurement. Primary WIFI AN 531 confirms that secondary WIFI AN 532 has an RSS above the RSS threshold. Secondary WIFI AN 532 will operate as a CA SCell.

If the uplink buffer in UE 501 has user data in excess of the CA threshold, then primary WIFI AN 531 signals UE 501 to transfer the excess portion of the uplink data to secondary WIFI AN 532. Primary WIFI AN 531 signals secondary WIFI AN 532 to receive this excess uplink data from UE 501 and to forward the excess uplink data to primary WIFI AN 531. In response, UE 501 transfers the excess portion of the uplink data to secondary WIFI AN 532, and secondary WIFI AN 532 forwards this excess uplink data to primary WIFI AN 531. UE 501 transfers the remaining portion of the uplink data directly to primary WIFI AN 531. Primary WIFI AN 531 transfers all of the uplink data to the external system over IWF 505 and UPF 508. UE 501 determines the SNR for secondary WIFI AN 532 during this uplink data transfer.

If the downlink buffer in WIFI AN 531 has user data for UE 501 in excess of the CA threshold, then primary WIFI AN 531 signals secondary WIFI AN 532 to receive this excess downlink data from primary WIFI AN 531 and forward the excess downlink data to UE 501. Primary WIFI AN 531 signals UE 501 to receive the excess downlink data from secondary WIFI AN 532. In response, primary WIFI AN 531 transfers the excess portion of the downlink data to secondary WIFI AN 532, and secondary WIFI AN 532 forwards this excess downlink data to UE 501. Primary WIFI AN 531 transfers the remaining portion of the downlink data directly to UE 501. UE 501 determines the SNR for secondary WIFI AN 532 during this downlink data transfer.

UE 501 subsequently reports its uplink buffer status to primary WIFI AN 531. Primary WIFI AN 531 determines its own downlink buffer status for UE 501. When one of the buffers exceeds the CA threshold, primary WIFI AN 531 determines if secondary WIFI AN 532 has more available bandwidth for UE 501 than AN 531 does. When secondary WIFI AN 532 has more available bandwidth, primary WIFI AN 531 transfers a message to UE 501 that requests the SNR for secondary WIFI AN 532. UE 501 reports the SNR for secondary WIFI AN 532 to primary WIFI AN 531. Primary WIFI AN 531 compares the SNR for secondary WIFI AN 532 to a corresponding SNR threshold. When secondary WIFI AN 532 meets or exceeds the SNR threshold, primary WIFI AN 531 offloads all of the buffered uplink data in UE 501 and/or all of the buffered downlink data in primary WIFI AN 531 to secondary WIFI AN 532. Note that all of the uplink and/or downlink data is offloaded and not just the excess portion of data above the CA threshold.

To offload the uplink data, primary WIFI AN 531 signals UE 501 to transfer all of its buffered uplink data to secondary WIFI AN 532. Primary WIFI AN 531 signals secondary WIFI AN 532 to receive all of this uplink data from UE 501 and to forward all of the uplink data to primary WIFI AN 531. In response, UE 501 transfers all of its buffered uplink data to secondary WIFI AN 532, and secondary WIFI AN 532 forwards all of this uplink data to primary WIFI AN 531. Primary WIFI AN 531 transfers all of the uplink data to the external system over IWF 505 and UPF 508.

To offload the downlink data, primary WIFI AN 531 signals secondary WIFI AN 532 to receive all of the downlink data from primary WIFI AN 531 and forward all of the downlink data to UE 501. Primary WIFI AN 531 signals UE 501 to receive all of the downlink data from secondary WIFI AN 532. In response, primary WIFI AN 531 transfers all of its buffered downlink data to secondary WIFI AN 532, and secondary WIFI AN 532 forwards all of this downlink data to UE 501.

In some examples, more than one secondary AN is selected and simultaneously used by UE 501 in the manner described herein. For example, UE 501 may simultaneously use both secondary 5GNR ANs 522-523 in parallel. In addition, any one of ANs 521-523, 531-533, and 541-543 may serve as the primary AN for UE 501, and any of the remaining ANs may serve as secondary ANs for UE 501. Thus, 5GNR AN 522 could be the primary AN, and 5GNR AN 523, WIFI AN 533, SAT AN 541 could be the secondary ANs for UE 501. Although not shown for clarity, ANs 521-523, 531-533, and 541-543 may be wirelessly linked to one another to handle the CA signaling and data transfers. For example, 5GNR ANs 521-523 may each be directly linked to SAT ANs 541-543 to handle CA signaling and CA data transfers.

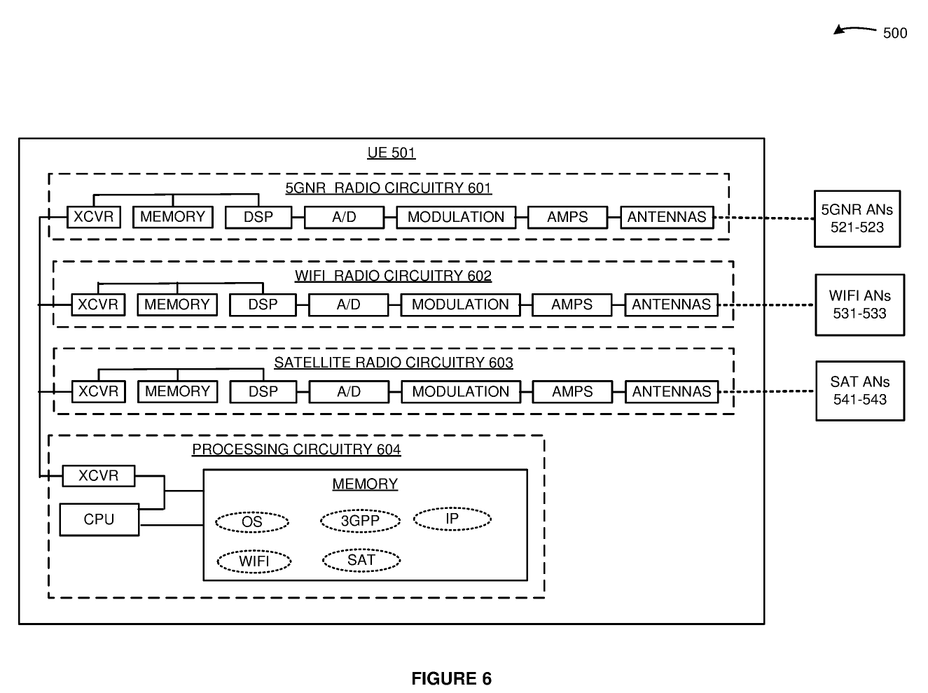

FIG. 6 illustrates an exemplary User Equipment (UE) 501 in wireless communication network 500 that offloads user data from primary Access Nodes (ANs) to secondary ANs. UE 501 comprises an example of wireless user device 101, although device 101 may differ. UE 501 comprises Fifth Generation New Radio (5GNR) radio circuitry 601, Wireless Fidelity (WIFI) radio circuitry 602, satellite radio circuitry 603, and processing circuitry 604. Radio circuitry 601-603 comprises antennas, amplifiers, filters, modulation, analog-to-digital interfaces, DSPs, memories, and transceivers (XCVRs) that are coupled over bus circuitry. Radio circuitry 601-603 are each capable of using multiple frequency bands in parallel. Processing circuitry 604 comprises one or more CPUs, one or more memories, and one or more transceivers that are coupled over bus circuitry. The one or more memories in processing circuitry 604 store software like an Operating System (OS), 3GPP Application (3GPP), WIFI Application (WIFI), Satellite Application (SAT), and Internet Protocol Application (IP). The antennas in radio circuitry 601-603 exchange wireless signals with ANs 521-523, 531-533, and 541-543. Transceivers in radio circuitry 601-603 are coupled to transceivers in processing circuitry 604. In processing circuitry 604, the one or more CPUs retrieve the software from the one or more memories and execute the software to direct the operation of UE 501 as described herein. In particular, UE 501 determines RSRP, SINR, BLER, and CQI for the secondary ANs and reports this information to primary the ANs. UE 501 uses the primary and secondary ANs in parallel as directed by the primary ANs.

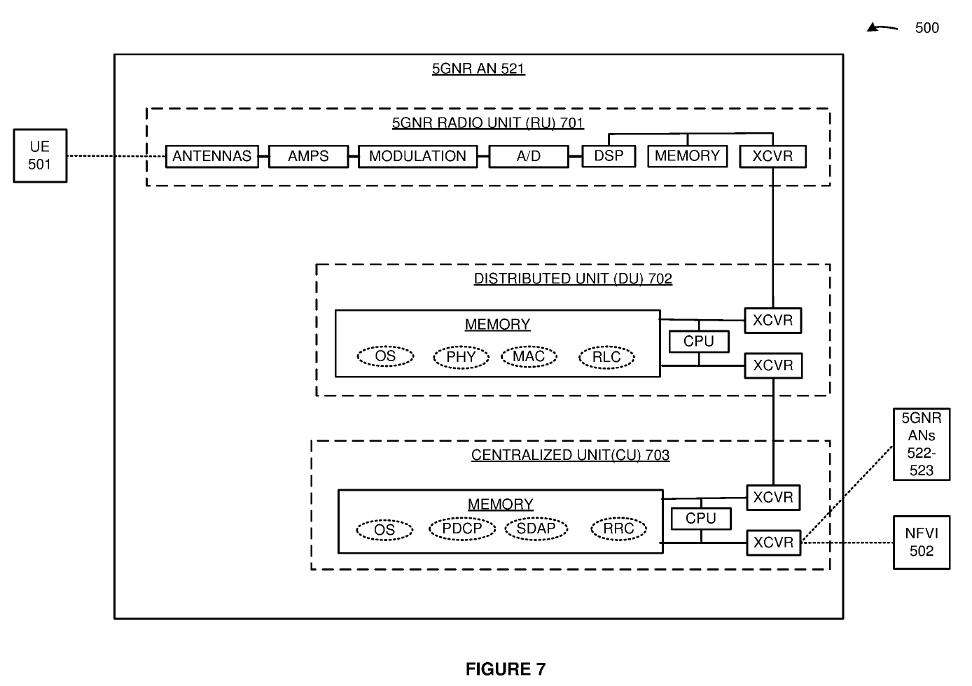

FIG. 7 illustrates an exemplary terrestrial Fifth Generation New Radio (5GNR) Access Node (AN) 521 in wireless communication network 500 that offloads user data to from primary 5GNR AN 521 to secondary 5GNR ANs 522-523. 5GNR AN 521 comprises an example of ANs 111-112 and 522-523, although ANs 111-112 and 522-523 may differ. 5GNR AN 521 comprises 5GNR Radio Unit (RU) 701, Distributed Unit (DU) 702, and Centralized Unit (CU) 703. 5GNR RU 701 comprises antennas, amplifiers, filters, modulation, analog-to-digital interfaces, DSP, memory, radio applications, and transceivers that are coupled over bus circuitry. RU 701 is capable of using multiple frequency bands in parallel. DU 702 comprises memory, CPU, and transceivers that are coupled over bus circuitry. The memory in DU 702 stores operating system and 5GNR network applications for Physical Layer (PHY), Media Access Control (MAC), and Radio Link Control (RLC). DU 702 is capable of using multiple frequency bands in parallel. CU 703 comprises memory, CPU, and transceivers that are coupled over bus circuitry. The memory in CU 703 stores an operating system and 5GNR network applications for Packet Data Convergence Protocol (PDCP), Service Data Adaption Protocol (SDAP), Radio Resource Control (RRC), and power control (PWR). The antennas in 5GNR RU 701 are wirelessly coupled to UE 501 over 5GNR links. Transceivers in 5GNR RU 701 are coupled to transceivers in DU 702. Transceivers in DU 702 are coupled to transceivers in CU 703. Transceivers in CU 703 are coupled to transceivers in NFVI 502 and 5GNR ANs 522-523. The DSP and CPU in RU 701, DU 702, and CU 703 execute the radio applications, operating systems, and network applications to exchange data and signaling between UE 501 and NFVI 502 as described herein. In particular, the MAC in primary 5GNR AN 521 selects the amount of user data to offload to secondary 5GNR ANs 522-523 based the AN bandwidths and the information from UE 501 like RSRP, SINR, BLER, and CQI. Primary 5GNR AN 521 exchanges user data directly with UE 501 and over secondary 5GNR ANs 522-523.

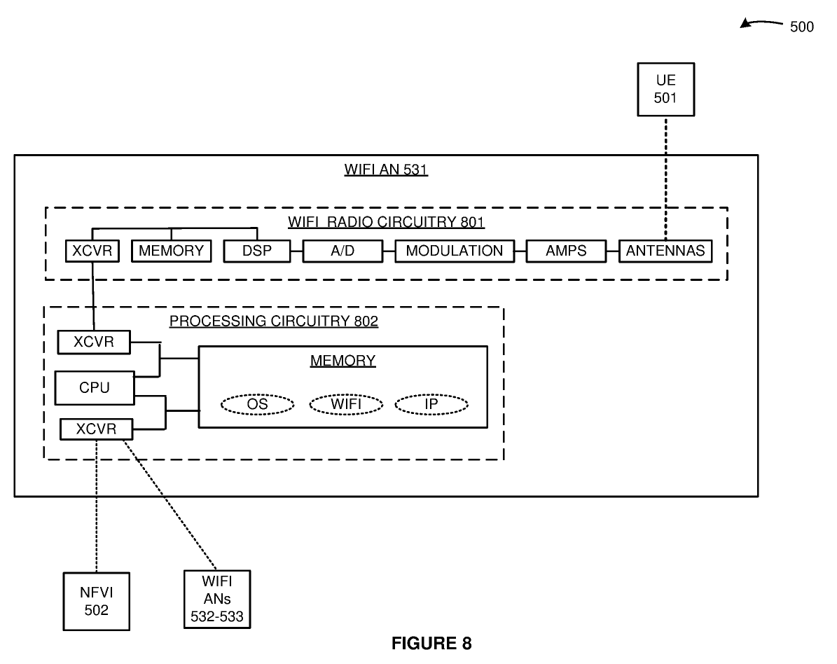

FIG. 8 illustrates exemplary Wireless Fidelity (WIFI) AN 431 in wireless communication network 500 that offloads user data from primary wireless ANs to second wireless ANs. WIFI AN 531 comprises an example of ANs 111-112 and 532-533, although ANs 111-112 and 532-533 may differ. WIFI AN 531 comprises WIFI radio circuitry 801 and processing circuitry 802. WIFI radio circuitry 801 comprises antennas, amplifiers, filters, modulation, analog-to-digital interfaces, DSPs, memories, and transceivers that are coupled over bus circuitry. Radio circuitry 801 may use multiple frequency bands in parallel. Processing circuitry 802 comprises one or more CPUs, one or more memories, and one or more transceivers that are coupled over bus circuitry. The one or more memories in processing circuitry 802 store software like an Operating System (OS), WIFI application (WIFI), and IP application (IP). The antennas in WIFI radio circuitry 801 exchange WIFI signals with UE 501. Transceivers in WIFI radio circuitry 801 are coupled to transceivers in processing circuitry 802. Transceivers in processing circuitry 802 are coupled to transceivers in NFVI 502 and WIFI ANs 532-533. In processing circuitry 802, the one or more CPUs retrieve the software from the one or more memories and execute the software to exchange data and signaling between UE 501 and NFVI 502 as described herein. In particular, the WIFI SW in primary WIFI AN 531 selects the amount of user data to offload to secondary WIFI ANs 532-533 based on the AN bandwidths and the information from UE 501 like RSS and SINR. Primary WIFI AN 531 exchanges user data directly with UE 501 and over secondary 5GNR ANs 532-533.

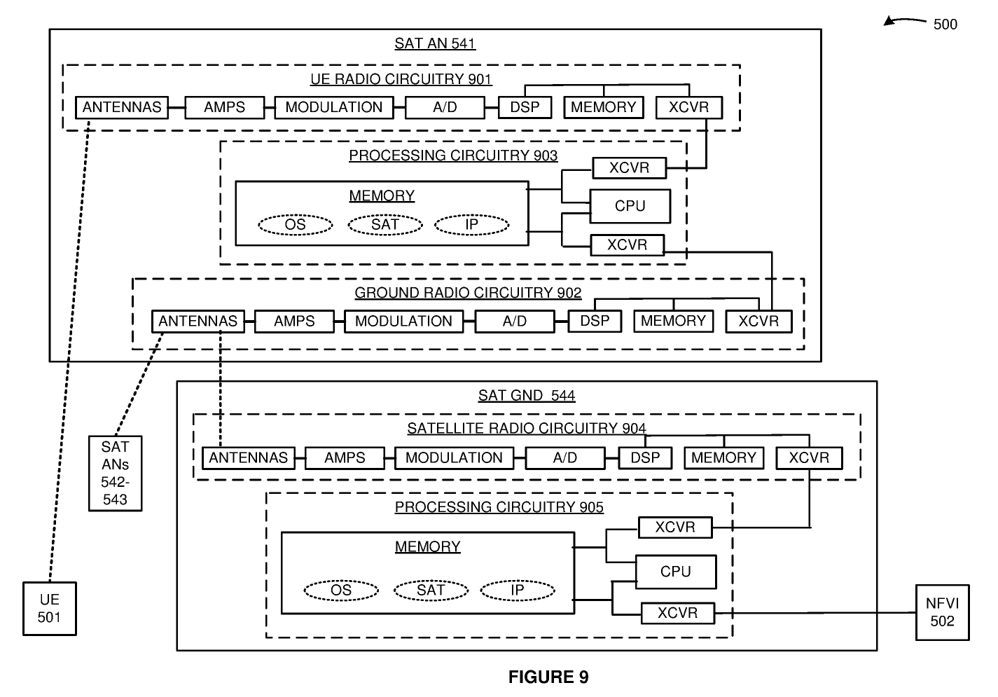

FIG. 9 illustrates an exemplary Satellite (SAT) AN and SAT Ground Station (GND) in the wireless communication network that offloads user data from primary SAT AN 541 to second SAT ANs 542-543. SAT AN 504 and SAT GND 505 comprises an example of ANs 110-112 and 542-543, although ANs 110-112 and 542-543 may differ. SAT AN 541 comprises UE radio 901, ground radio 902, and processing circuitry 903. SAT GND 505 comprises satellite radio circuitry 904 and processing circuitry 905. Radio circuitry 901-902 and 904 comprise antennas, amplifiers, filters, modulation, analog-to-digital interfaces, DSPs, memories, transceivers, and power supplies that are coupled over bus circuitry. Radio circuitry may use multiple frequency bands in parallel. Processing circuitry 903 and 905 comprise one or more CPUs, one or more memories, and one or more transceivers that are coupled over bus circuitry. The one or more memories in processing circuitry 903 and 905 store software like an Operating System (OS), Satellite Application (SAT), and IP Application (IP). The antennas in UE radio circuitry 901 exchange satellite signals with UE 501. Transceivers in UE radio circuitry 901 are coupled to transceivers in processing circuitry 903. Transceivers in processing circuitry 903 are coupled to transceivers in ground radio circuitry 902. The antennas in ground radio circuitry 902 exchange satellite signals with antennas in satellite radio circuitry 904, and the antennas in satellite radio circuitry 904 exchange the satellite signals with ground radio circuitry 902 and SAT ANs 542-543. Transceivers in satellite radio circuitry 904 are coupled to transceivers in processing circuitry 905. Transceivers in processing circuitry 905 are coupled to transceivers in NFVI 502. In processing circuitry 903 and 905, the one or more CPUs retrieve the software from the one or more memories and execute the software to exchange data and signaling between UEs 501 and NFVI 502 as described herein. In particular, the SAT software in primary SAT AN 541 selects the amount of user data to offload to secondary SAT ANs 542-543 based the AN bandwidths and the information from UE 501 like RSS, SINR, and ER. Primary SAT AN 541 exchanges user data directly with UE 501 and over secondary SAT ANs 542-543.

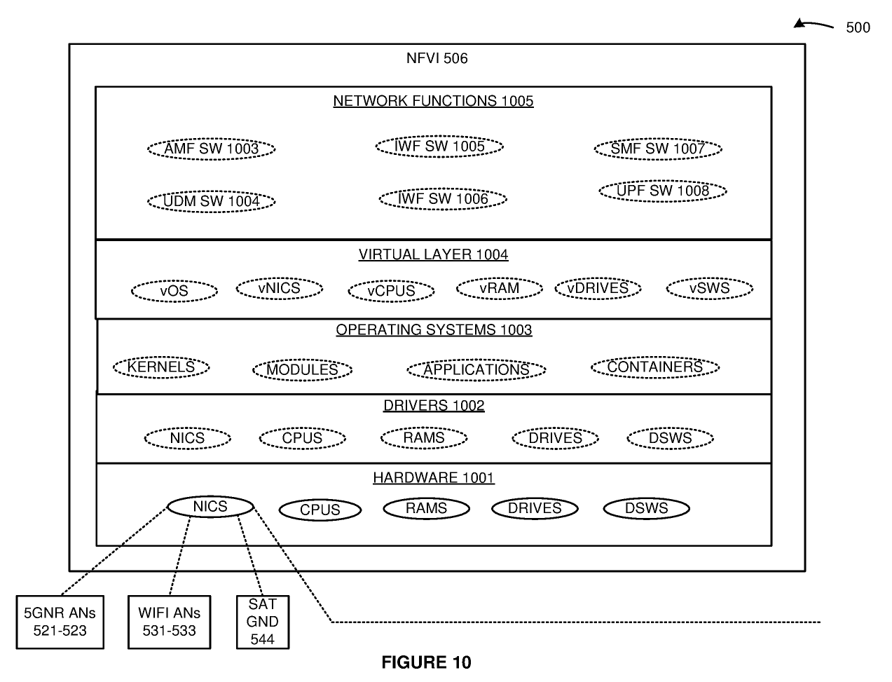

FIG. 10 illustrates an exemplary Network Function Virtualization Infrastructure (NFVI) in wireless communication network 500 that offloads user data from the primary wireless ANs to secondary wireless ANs. NFVI 502 comprises hardware 1001, hardware drivers 1002, operating systems 1003, virtual layer 1004, and network functions 1005. Hardware 1001 comprises Network Interface Cards (NICS), CPUs, RAM, Flash/Disk Drives (DRIVES), and Data Switches (DSWS). Hardware drivers 1002 comprise software that is resident in the NICS, CPUs, RAM, DRIVES, and DSWS. Operating systems 1003 comprise kernels, modules, applications, and containers. Virtual layer 1004 comprises virtual Operating Systems (vOS), vNICS, vCPUS, vRAM, vDRIVES, and vSWS. Network Functions 1005 comprises AMF SW 1003, UDM SW 1004, IWF SW 1005-1006, SMF SW 1007, and UPF SW 1008. The NICS in hardware 1001 are coupled to 5GNR ANs 521-523, WIFI ANs 531-533, SAT GND 544, and external systems. Hardware 1001 executes hardware drivers 1002, operating systems 1003, virtual layer 1004, and network functions 1005 to form and operate AMF 503, UDM 504, IWFs 505-506, SMF 507, and UPF 508 as described herein. NFVI 502 may be located at a single site or be distributed across multiple geographic areas.

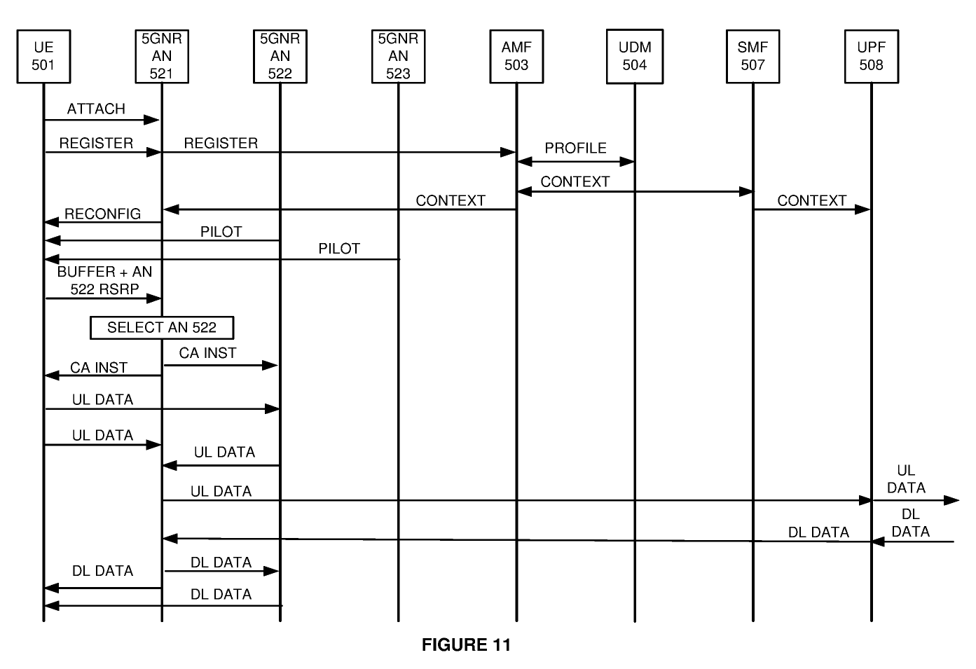

FIG. 11 illustrates an exemplary operation of wireless communication network 500 for primary 5GNR AN 521 to select and use secondary 5GNR AN 522. The operation may differ in other examples. UE 501 attaches to 5GNR AN 521 which will operate as the primary CA PCell. UE 501 registers with AMF 503 over primary 5GNR AN 521 and indicates its CA capability to primary 5GNR AN 521. AMF 503 retrieves the subscriber profile for UE 501 from UDM 504. AMF 503 and SMF 507 interact to develop context for UE 501 like device and node identifiers, network addresses, and data rates. SMF 507 transfers the context to UPF 508. AMF 503 transfers the context to primary 5GNR AN 521. Primary 5GNR AN 521 transfers a Radio Resource Control (RRC) Reconfiguration message to UE 501. The RRC Reconfiguration message requests that UE 501 take RSRP measurements for secondary 5GNR ANs 522-523 and report when AN 522 and/or 523 have an RSRP above an RSRP threshold. The RRC Reconfiguration message also requests that UE 501 report SINR, BLER, and CQI measurements for selected ones of secondary 5GNR ANs 522-523. UE 501 processes pilot signals from secondary 5GNR ANs 522-523 to measure their RSRP. In this example, UE 501 reports secondary 5GNR 522 because AN 522 has an RSRP above the RSRP threshold. UE 501 does not report AN 523 because AN 523 does not have an RSRP above the RSRP threshold. UE 501 reports its own buffer status and the RSRP for 5GNR AN 522 to primary 5GNR AN 521.

In response to the buffers for UE 501 and 5GNR AN 521 exceeding their CA thresholds, primary 5GNR AN 521 selects secondary 5GNR AN 522 because AN 522 has an RSRP above the RSRP threshold. Primary 5GNR AN 521 signals CA instructions (INST) to UE 501 and secondary 5GNR AN 522 to exchange user data. UE 501 transfers the portion of Uplink (UL) data that exceeds the CA buffer threshold to secondary 5GNR AN 522 and transfers the remaining UL data to primary 5GNR 521. Secondary 5GNR AN 522 transfers the excess portion of UL data to primary 5GNR AN 521. Primary 5GNR AN 521 transfers all of the UL data to an external system (not shown) over UPF 508.

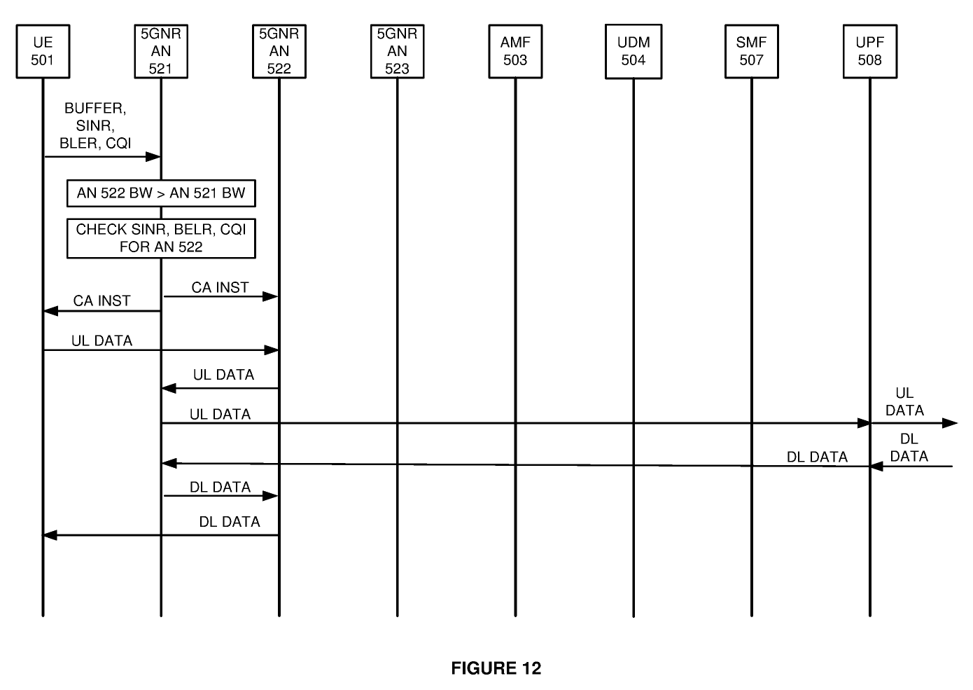

Primary 5GNR AN 521 receives Downlink (DL) data for UE 501 from the external system over UPF 508. Primary 5GNR AN 521 transfers the excess portion of DL data that exceeds its CA buffer threshold to secondary 5GNR AN 522. Primary 5GNR AN 521 transfers the remaining DL data to UE 501. Secondary 5GNR AN 522 transfers the excess DL data from 5GNR AN 521 to UE 501. UE 501 measures SINR, BLER, and CQI for secondary 5GNR AN 522 during these data transfers. The operation continues below with a discussion of FIG. 12.

FIG. 12 illustrates an exemplary operation of wireless communication network 500 to select a data amount to offload from the primary 5GNR AN 521 to secondary 5GNR AN 522. The operation may differ in other examples and continues from the above discussion of FIG. 11. UE 501 reports its buffer status along with the SINR, BLER, and CQI for secondary 5GNR AN 522 to primary 5GNR AN 521.

In response to the buffers for UE 501 and primary 5GNR AN 521 exceeding their CA buffer thresholds, primary 5GNR AN 521 determines if the secondary bandwidth of secondary 5GNR AN 522 meets or exceeds the primary bandwidth of primary 5GNR AN 521, and if so, AN 521 proceeds to analyze the SINR for secondary AN 522. If not, then primary 5GNR AN 521 reverts to the CA operation described in FIG. 11. In this example, primary 5GNR AN 522 has a bandwidth of 100 megahertz and secondary 5GNR AN 522 has a secondary bandwidth of 200 megahertz, so primary 5GNR AN 521 proceeds to the SINR analysis.

Primary 5GNR AN 521 determines if the SINR for secondary 5GNR AN 522 meets or exceeds a SINR threshold, and if so, primary 5GNR AN 521 analyzes BLER for secondary 5GNR AN 522. If not, then primary 5GNR AN 521 reverts to the CA operation described in FIG. 11. In this example, secondary 5GNR AN 522 has a SINR of 15 decibels and the SINR threshold is 10 decibels, so primary 5GNR AN 521 proceeds to the BLER analysis.

Primary 5GNR AN 521 determines if the BLER for secondary 5GNR AN 522 meets or falls below a BLER threshold, and if so, primary 5GNR AN 521 analyzes CQI for secondary 5GNR AN 522. If not, then primary 5GNR AN 521 reverts to the CA operation described in FIG. 11. In this example, secondary 5GNR AN 522 has a BLER of 7% and the BLER threshold is 10%, so primary 5GNR AN 521 proceeds to the CQI analysis.

Primary 5GNR AN 521 determines if the CQI for secondary 5GNR AN 522 meets or exceeds a CQI threshold, and if so, primary 5GNR AN 521 proceeds to offload data to secondary 5GNR AN 522. If not, then primary 5GNR AN 521 reverts to the CA operation described in FIG. 11. In this example, secondary 5GNR AN 522 has a CQI of 10 and the CQI threshold is 9, so primary 5GNR AN 521 proceeds with the offload.

To implement the offload, primary 5GNR AN 521 signals CA instructions to UE 501 and secondary 5GNR AN 522 to exchange all of their buffered user data. UE 501 transfers all of its buffered UL data to secondary 5GNR AN 522. Secondary 5GNR AN 522 transfers all of this UL data to primary 5GNR AN 521. Primary 5GNR AN 521 transfers all of the UL data to the external system over UPF 508. Primary 5GNR AN 521 receives DL data for UE 501 from the external system over UPF 508. Primary 5GNR AN 521 transfers all of its buffered DL data for UE 501 to secondary 5GNR AN 522. Secondary 5GNR AN 522 transfers all of this DL data to UE 501.

Advantageously, wireless communication network 500 efficiently offloads entire amounts of buffered user data for UE 501 from primary wireless ANs 521, 531, and 541 to secondary wireless ANs 522-523, 532-533, and 542-543. Moreover, primary wireless ANs 521, 531, and 541 verify the ability of secondary wireless ANs 522-523, 532-533, and 542-543 to handle these total offloads before the offloads are attempted.

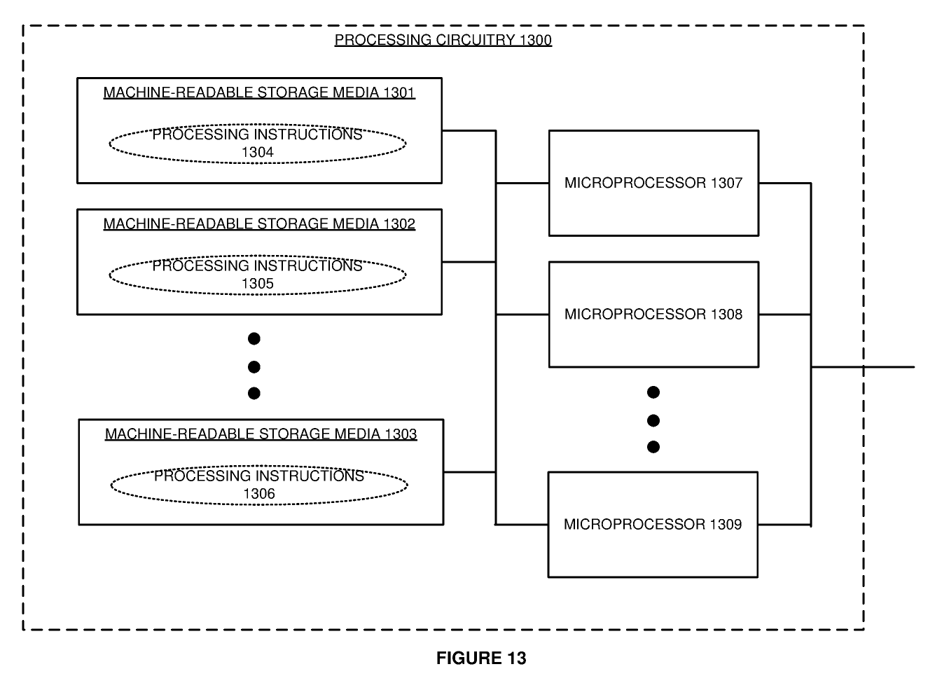

FIG. 13 illustrates exemplary processing circuitry 1300 to offload user data from a primary wireless access node to a secondary wireless access node. Processing circuitry 1300 comprises an example of data system 100 and wireless communication network 500, although system 100 and network 500 may differ. Processing circuitry 1300 comprises machine-readable storage media 1301-1303 and microprocessors 1307-1309 that are communicatively coupled. Machine-readable storage media 1301-1303 store processing instructions 1304-1306 in a non-transitory manner. Microprocessors 1307-1309 comprise DSPs, CPUs, GPUs, ASICs, and/or some other data processing hardware. Machine-readable storage media 1301-1303 comprises RAM, flash circuitry, disk drives, and/or some other type of data storage apparatus. Microprocessors 1307-1309 retrieve processing instructions 1304-1306 from non-transitory machine-readable storage media 1301-1303. Microprocessors 1307-1309 execute processing instructions 1304-1306 to offload user data to secondary ANs as described above. The amount of storage media, microprocessors, processing instructions that are shown in FIG. 13 may vary in other examples.

The wireless communication system circuitry described above comprises computer hardware and software that form special-purpose data communication circuitry to offload user data from a first wireless access node to a second wireless access node. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry to offload user data from a first wireless access node to a second wireless access node.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A method comprising:
selecting a first amount of user data for a first wireless access node to wirelessly transfer to a wireless user device;
selecting a second amount of the user data for a second wireless access node to wirelessly transfer to the wireless user device;
determining one or more wireless communication characteristics for the wireless transfer of the second amount of the user data; and
based on the one or more wireless communication characteristics, selecting an entire amount of additional user data for the first wireless access node to transfer to the second wireless access node and for the second wireless access node to wirelessly transfer to the wireless user device.

2. The method of claim 1 wherein:
determining the one or more wireless communication characteristics comprises determining a Signal-to-Interference and Noise Ratio (SINR); and
selecting the entire amount of the additional user data comprises selecting the entire amount of the additional user data based on the SINR.

3. The method of claim 1 wherein:
determining the one or more wireless communication characteristics comprises determining a Block Error Rate (BLER); and
selecting the entire amount of the additional user data comprises selecting the entire amount of the additional user data based on the BLER.

4. The method of claim 1 wherein:
determining the one or more wireless communication characteristics comprises determining a Channel Quality Indicator (CQI) for the wireless transfer of the second portion of the user data from the second wireless access node to the wireless user device; and
selecting the entire amount of the additional user data comprises selecting the entire amount of the additional user data based on the CQI.

5. The method of claim 1 wherein:
determining the one or more wireless communication characteristics comprises determining a first bandwidth for the first wireless access node and determining a second bandwidth for the second wireless access node; and
selecting the entire amount of the additional user data comprises selecting the entire amount the of additional user data based on the first bandwidth for the first wireless access node and the second bandwidth for the second wireless access node.

6. The method of claim 1 wherein:
the first wireless access node comprises a Carrier Aggregation Primary Cell (CA PCell); and
the second wireless access node comprises a Carrier Aggregation Secondary Cell (CA SCell).

7. A method comprising:
selecting a first amount of user data for a wireless user device to wirelessly transfer to a first wireless access node;
selecting a second amount of the user data for the wireless user device to wirelessly transfer to a second wireless access node;
determining one or more wireless communication characteristics for the wireless transfer of the second amount of the user data; and
based on the one or more wireless communication characteristics, selecting an entire amount of additional user data for the wireless user device to wirelessly transfer to the second wireless access node and for the second wireless access node to transfer to the first wireless access node.

8. The method of claim 7 wherein:
determining the one or more wireless communication characteristics comprises determining a Signal-to-Interference and Noise Ratio (SINR); and
selecting the entire amount of the additional user data comprises selecting the entire amount of the additional user data based on the SINR.

9. The method of claim 7 wherein:
determining the one or more wireless communication characteristics comprises determining a Block Error Rate (BLER); and
selecting the entire amount of the additional user data comprises selecting the entire amount of the additional user data based on the BLER.

10. The method of claim 7 wherein:
determining the one or more wireless communication characteristics comprises determining a Channel Quality Indicator (CQI); and
selecting the entire amount of the additional user data based comprises selecting the entire amount of the additional user data based on the CQI.

11. The method of claim 7 wherein:
determining the one or more wireless communication characteristics comprises determining a first bandwidth for the first wireless access node and determining a second bandwidth for the second wireless access node; and
selecting the entire amount of the additional user data comprises selecting the entire amount the of additional user data based on the first bandwidth for the first wireless access node and the second bandwidth for the second wireless access node.

12. The method of claim 7 wherein:
the first wireless access node comprises a Carrier Aggregation Primary Cell (CA PCell); and
the second wireless access node comprises a Carrier Aggregation Secondary Cell (CA SCell).

13. A data system comprising:
a first wireless access node to wirelessly transfer a first amount of user data between a wireless user device and the first wireless access node;
a second wireless access node to wirelessly transfer a second amount of user data between the wireless user device and the second wireless access node;
the first wireless access node to determine one or more wireless communication characteristics for the wireless transfer of the second amount of the user data between the wireless user device and the second wireless access node;
the first access node to select an entire amount of additional user data based on the one or more wireless communication characteristics;
the first wireless access node to transfer the entire amount of the additional user data between the second wireless access node and the first wireless access node; and
the second wireless access node to transfer the entire amount of the additional user data between the second wireless access node and the first wireless access node and to wirelessly transfer the entire amount of the additional user data between the wireless user device and the second wireless access node.

14. The data system of claim 13 wherein:
the user data comprises uplink user data that is wirelessly transferred from the wireless user device to the first second wireless access node and the second wireless access node; and
the additional user data comprises additional uplink user data that is wirelessly transferred from the wireless user device to the second wireless access node.

15. The data system of claim 13 wherein:
the user data comprises downlink user data that is wirelessly transferred from the first wireless access node and the second wireless access node to the wireless user device; and
the additional user data comprises additional downlink user data that is wirelessly transferred from the first wireless access node and the second wireless access node to the wireless user device.

16. The data system of claim 13 wherein the one or more wireless communication characteristics comprise Signal-to-Interference and Noise Ratio (SINR).

17. The data system of claim 13 wherein the one or more wireless communication characteristics comprise Block Error Rate (BLER).

18. The data system of claim 13 wherein the one or more wireless communication characteristics comprise a Channel Quality Indicator (CQI).

19. The data system of claim 13 wherein the one or more wireless communication characteristics comprise a first bandwidth for the first wireless access node and a second bandwidth for the second wireless access node.

20. The data system of claim 13 wherein:
the first wireless access node comprises a Carrier Aggregation Primary Cell (CA PCell); and
the second wireless access node comprises a Carrier Aggregation Secondary Cell (CA SCell).
